(19) United States
(12) Patent Application Publication
(10) Pub. No.: US 2015/0042584 A1
(43) Pub. Date: Feb. 12, 2015

(54) ELECTRONIC DEVICE AND METHOD FOR EDITING OBJECT USING TOUCH INPUT

(71) Applicant: Samsung Electronics Co., Ltd., Suwon-si (KR)

(72) Inventors: Nina LEE, Suwon-si (KR); Jungeui SEO, Anyang-si (KR); Juhyun KO, Seoul (KR)

(21) Appl. No.: 14/451,973

(22) Filed: Aug. 5, 2014

(30) Foreign Application Priority Data
Aug. 6, 2013 (KR) 10-2013-0092907

(51) Int. Cl. G06F 3/0484; G06F 3/0488; G06F 3/041

(52) U.S. Cl. CPC G06F 3/04845; G06F 3/0416; G06F 3/0412; G06F 3/04842; G06F 3/0488
USPC 345/173

(57) ABSTRACT

An electronic device selectively edits a displayed object through a touch input is provided. In an edit method, the electronic device displays one or more objects each of which includes at least one of image information and shape information. Then the electronic device detects a touch event for selecting at least one of the displayed objects, and detects another touch event for editing at least one of a size, a position, and an arrangement of the at least one selected object. In response to the editing touch event, the electronic device performs an edit process for at least one of the size, the position, and the arrangement of the at least one selected object.

### CROSS-REFERENCE TO RELATED APPLICATION(S)

This application claims the benefit under 35 U.S.C. §119(a) of a Korean patent application filed on Aug. 6, 2013 in the Korean Intellectual Property Office and assigned Serial number 10-2013-0092907, the entire disclosure of which is hereby incorporated by reference.

### TECHNICAL FIELD

The present disclosure relates to a method for editing an object through a touch input and an electronic device implementing the method.

### BACKGROUND

Normally a variety of mobile electronic devices today such as a smart phone and a tablet Personal Computer (PC) can be manipulated through a user's touch input that occurs directly and intuitively.

A touch input may occur by means of a suitable input tool such as a user's finger, a stylus pen, or any other physical or electronic equivalent. Recently there are increasing demands for editing images or documents in an intuitive manner through a touch input.

However, typical electronic devices require the navigation or entrance into a special edit menu for allowing an edit of images or documents. Therefore, there is a need for improving the utilization of a touch input in an electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a technique to edit an object having at least one of image information, shape information and color information through a touch input in an electronic device.

In accordance with aspect of the present disclosure, a method for editing an object through a touch input in an electronic device is provided. The method includes displaying one or more objects each of which includes at least one of image information and shape information, detecting a selecting touch event for selecting at least one of the one or more displayed objects, detecting an editing touch event for editing at least one of a size, a position, and an arrangement of the at least one selected object, and performing an edit process for at least one of the size, the position, and the arrangement of the selected object in response to the editing touch event.

In accordance with another aspect of the present disclosure, a method for editing an object through a touch input in an electronic device is provided. The method includes displaying one or more objects each of which includes at least one of color information, image information, and shape information, detecting a touch event for selecting at least one of the one or more displayed objects, displaying at least one of the color information, the image information and the shape information to be applied to the at least one selected object, detecting a touch event for selecting one of the color information, the image information and the shape information, and applying the selected one of the color information, the image information and the shape information to the at least one selected object.

In accordance with another aspect of the present disclosure, an electronic device is provided. The electronic device includes a touch screen configured to display one or more objects each of which includes at least one of image information and shape information, in response to a touch input, and a control unit configured to detect a selecting touch event for selecting at least one of the displayed objects through the touch screen, to detect an editing touch event for editing at least one of a size, a position, and an arrangement of the at least one selected object through the touch screen, and to perform an edit process for at least one of the size, the position, and the arrangement of the at least one selected object in response to the editing touch event.

In accordance with another aspect of the present disclosure, an electronic device is provided. The electronic device includes a touch screen configured to display one or more objects each of which includes at least one of color information, image information, and shape information, in response to a touch input, and a control unit configured to detect a touch event for selecting at least one of the one or more displayed objects through the touch screen, to control the touch screen to display at least one of the color information, the image information, and the shape information to be applied to the at least one selected object, to detect a touch event for selecting one of the color information, the image information and the shape information through the touch screen, and to apply the selected one of the color information, the image information and the shape information to the at least one selected object.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to an embodiment of the present disclosure.

FIG. 2 is a flow diagram illustrating a method for editing a size of an object through a touch input according to an embodiment of the present disclosure.

FIGS. 3A and 3B are screenshots illustrating a process of editing a size of an object through a touch input according to an embodiment of the present disclosure.

FIG. 4 is a flow diagram illustrating a method for editing a position of an object through a touch input according to an embodiment of the present disclosure.

FIGS. 5A and 5B are screenshots illustrating a process of editing a position of an object through a touch input according to an embodiment of the present disclosure.

FIG. 6 is a flow diagram illustrating a method for arranging a position of an object through a touch input according to an embodiment of the present disclosure.

FIGS. 7A, 7B, 7C, 7D, 7E, 7F, 7G, and 7H are screenshots illustrating a process of arranging a position of an object through a touch input according to an embodiment of the present disclosure.

FIG. 8 is a flow diagram illustrating a method for editing an object through a touch input according to an embodiment of the present disclosure.

FIG. 9 is a flow diagram illustrating a method for editing color information of an object through a touch input according to an embodiment of the present disclosure.

FIG. 10 is a screenshot illustrating a process of editing color information of an object through a touch input according to an embodiment of the present disclosure.

FIG. 11 is a flow diagram illustrating a method for editing a color filter effect of an object through a touch input according to an embodiment of the present disclosure.

FIGS. 12A, 12B, and 12C are screenshots illustrating a process of editing a color filter effect of an object through a touch input according to an embodiment of the present disclosure.

FIG. 13 is a flow diagram illustrating a method for editing a mask of an object through a touch input according to an embodiment of the present disclosure.

FIGS. 14A, 14B, and 14C are screenshots illustrating a process of editing a mask of an object through a touch input according to an embodiment of the present disclosure.

FIG. 15 is a flow diagram illustrating a method for editing shape information of an object through a touch input according to an embodiment of the present disclosure.

FIGS. 16A, 16B, 16C, 16D, 16E, and 16F are screenshots illustrating a process of editing shape information of an object through a touch input according to an embodiment of the present disclosure.

FIG. 17 is a flow diagram illustrating a method for editing image information of an object through a touch input according to an embodiment of the present disclosure.

FIGS. 18A, 18B, 18C, and 18D are screenshots illustrating a process of editing image information of an object through a touch input according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “an object” includes reference to one or more of such objects.

According to various embodiments of the present disclosure, an electronic device may include communication functionality. For example, an electronic device may be a smart phone, a tablet Personal Computer (PC), a mobile phone, a video phone, an e-book reader, a desktop PC, a laptop PC, a netbook PC, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic appcessory, an electronic tattoo, or a smart watch), and/or the like.

According to various embodiments of the present disclosure, an electronic device may be a smart home appliance with communication functionality. A smart home appliance may be, for example, a television, a Digital Video Disk (DVD) player, an audio, a refrigerator, an air conditioner, a vacuum cleaner, an oven, a microwave oven, a washer, a dryer, an air purifier, a set-top box, a TV box (e.g., Samsung HomeSync™, Apple TV™, or Google TV™), a gaming console, an electronic dictionary, an electronic key, a camcorder, an electronic picture frame, and/or the like.

According to various embodiments of the present disclosure, an electronic device may be a medical device (e.g., Magnetic Resonance Angiography (MRA) device, a Magnetic Resonance Imaging (MRI) device, Computed Tomography (CT) device, an imaging device, or an ultrasonic device), a navigation device, a Global Positioning System (GPS) receiver, an Event Data Recorder (EDR), a Flight Data Recorder (FDR), an automotive infotainment device, a naval electronic device (e.g., naval navigation device, gyroscope, or compass), an avionic electronic device, a security device, an industrial or consumer robot, and/or the like.

According to various embodiments of the present disclosure, an electronic device may be furniture, part of a building/structure, an electronic board, electronic signature receiving device, a projector, various measuring devices (e.g., water, electricity, gas or electro-magnetic wave measuring devices), and/or the like that include communication functionality.

According to various embodiments of the present disclosure, an electronic device may be any combination of the foregoing devices. In addition, it will be apparent to one having ordinary skill in the art that an electronic device according to various embodiments of the present disclosure is not limited to the foregoing devices.

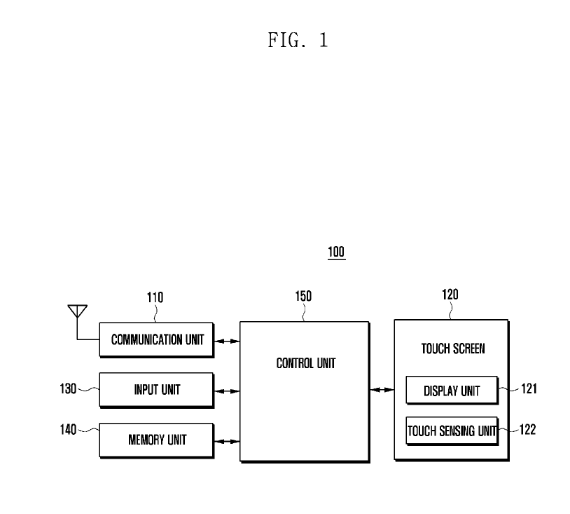

FIG. 1 is a block diagram illustrating an electronic device 100 according to an embodiment of the present disclosure.

Referring to FIG. 1, the electronic device 100 includes a communication unit 110, a touch screen 120, an input unit 130, a memory unit 140, and a control unit 150.

The communication unit 110 supports a wireless communication function of the electronic device 100 and may be configured as a mobile communication module in case the electronic device 100 supports a mobile communication function. The communication unit 110 may include a Radio Frequency (RF) transmitter that up-converts the frequency of an outgoing signal and then amplifies the signal, an RF receiver that amplifies with low-noise an incoming signal and down-converts the frequency of the signal, and the like. The communication unit 110 may support a short-range communication function. For example, the communication unit 110 may include a Wi-Fi module, a Bluetooth module, a Zigbee module, a Ultra Wide Band (UWB) module, an Near Field Communication (NFC) module, and/or the like. According to various embodiments of the present disclosure, the communication unit 110 may transmit and/or receive, to or from a specific server or any other electronic device, one or more objects each of which includes at least one of image information, shape information, and color information.

The touch screen 120 may be an input/output unit for simultaneously performing both an input function and a display function. The touch screen 120 may include a display unit 121 and a touch sensing unit 122. Specifically, the touch screen 120 may display various screens (e.g., a media content playback screen, a call dialing screen, a messenger screen, a game screen, a gallery screen, and/or the like) associated with the operation of the electronic device 100 through the display unit 121. Additionally, if any user event (e.g., a touch event or a hovering event) is detected from the touch sensing unit 122 while the display unit 121 displays a certain screen, the touch screen 120 may transmit an input signal based on the detected user event to the control unit 150. The control unit 150 may identify the received user event and perform a particular operation in response to the identified user event.

The display unit 121 may display information processed in the electronic device 100. For example, when the electronic device 100 is in a call mode, the display unit 121 may display a User Interface (UI) or a Graphic UI (GUI) in connection with the call mode. Similarly, when the electronic device 100 is in a video call mode or a camera mode, the display unit 121 may display a received or captured image, UI, or GUI. Further, depending on a rotation direction (or placed direction) of the electronic device 100, the display unit 121 may display a screen in a landscape mode or a portrait mode and, if necessary, indicate a notification of a screen switch caused by a change between such modes.

The display unit 121 may be formed of Liquid Crystal Display (LCD), Thin Film Transistor-LCD (TFT-LCD), Light Emitting Diode (LED), Organic LED (OLED), Active Matrix OLED (AMOLED), flexible display, bended display, 3D display, and/or the like. Parts of such displays may be realized as transparent display.

The touch sensing unit 122 may be placed on the display unit 121 and detect a user's touch event (e.g., a long press input, a short press input, a single-touch input, a multi-touch input, a touch-based gesture input such as a drag input, and/or the like) from the surface of the touch screen 120. When such a touch event is detected from the surface of the touch screen 120, the touch sensing unit 122 may detect coordinates of the detected touch event and transmit a signal of the detected coordinates to the control unit 150. Based on a received signal, the control unit 150 may perform a particular function corresponding to a detected position of the touch event.

The touch sensing unit 122 may be configured to convert a pressure applied to a certain point of the display unit 121 or a variation in capacitance produced at a certain point of the display unit 121 into an electric input signal. Depending on a touch type, the touch sensing unit 122 may be configured to detect the pressure of a touch as well as the position and area thereof. If a touch input is input on the touch sensing unit 122, a corresponding signal or signals may be transmitted to a touch controller (not shown). The touch controller may process such a signal or signals and transmit resultant data to the control unit 150. Therefore, the control unit 150 may determine which point of the touch screen 120 is touched.

The input unit 130 may receive a user's manipulation and create input data for controlling the operation of the electronic device 100. The input unit 130 may be selectively composed of a keypad, a dome switch, a touchpad, a jog wheel, a jog switch, various sensors (e.g., a voice recognition sensor, a proximity sensor, an illuminance sensor, an acceleration sensor, a gyro sensor, a geomagnetic sensor, a motion sensor, an image sensor, etc.), and/or the like. Additionally, the input unit 130 may be formed of buttons installed at the external side of the electronic device 100, some of which may be realized in a touch panel.

The memory unit 140 may permanently or temporarily store therein an operating system for booting the electronic device 100, a program and/or application required for performing a particular function of the electronic device 100, and data created during the use of the electronic device 100. The memory unit 140 may be composed of Read Only Memory (ROM), Random Access Memory (RAM), and any other similar memory or storage medium. According to various embodiments of the present disclosure, the memory unit 140 may store therein one or more objects each of which includes at least one of image information, shape information, and color information. Additionally, under the control of the control unit 150, the memory unit 140 may store therein such an object received through the communication unit 110. Further, under the control of the control unit 150, such an object stored in the memory unit 140 may be edited and outputted to the display unit 121 of the touch screen 120 or transmitted through the communication unit 110.

The control unit 150 may control the overall operation of the electronic device 100. Specifically, the control unit 150 may control the touch screen 120 to display thereon one or more objects each of which includes at least one of image information, shape information, and color information. Additionally, the control unit 150 may detect, through the touch screen 120, a touch event for selecting an object or objects to be edited among the displayed objects. Further, the control unit 150 may control the touch screen 120 to display thereon at least one of color information, image information, and shape information to be applied to the selected object. In addition, the control unit 150 may detect, through the touch screen 120, a touch event for selecting specific one of the displayed color information, image information, and shape information. In addition, the control unit 150 may apply the selected color information, image information, or shape information to the selected object and then control the touch screen 120 to display thereon the selected object having the applied information.

Additionally, the control unit 150 may detect, through the touch screen 120, a touch event for editing the size, position, arrangement, and/or the like of one or more objects each of which includes at least one of image information, shape information and color information. In response to such a touch event, the control unit 150 may control the touch screen 120 to display thereon the size-adjusted, moved, arranged, and/or the like object or objects in an overlay form or by means of a numerical value. When such a touch event is removed, the control unit 150 may finish such an edit process at a position from which the touch event is removed.

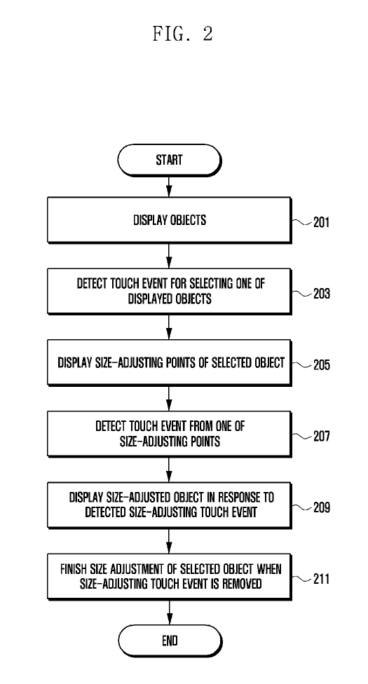

FIG. 2 is a flow diagram illustrating a method for editing a size of an object through a touch input according to an embodiment of the present disclosure.

Referring to FIG. 2, at operation 201, the electronic device 100 displays one or more objects. Each of the one or more objects may include at least one of image information and shape information.

At operation 203, the electronic device 100 detects a touch event for selecting one of such objects.

At operation 205, in response to the detected object-selecting touch event, the electronic device 100 displays size-adjusting points to be used for adjusting the size of the selected object.

At operation 207, the electronic device 100 detects a touch event from one of the size-adjusting points.

At operation 209, in response to the detected size-adjusting touch event, the electronic device 100 displays a size-adjusted object. At this operation, the electronic device 100 may display both objects before and after the size adjustment in an overlay form, and/or may display the quantity of the size adjustment by means of a numerical value.

At operation 211, when the size-adjusting touch event is removed, the electronic device 100 finishes the size adjustment of the selected object. For example, the electronic device 100 finishes the size adjustment of the selected object at a position from which the touch event is removed.

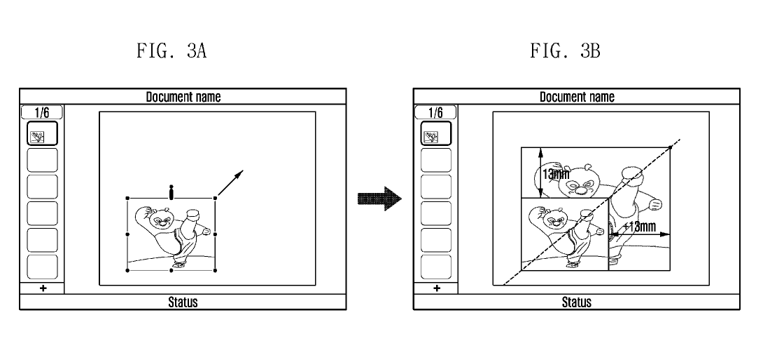

FIGS. 3A and 3B are screenshots illustrating a process of editing a size of an object through a touch input according to an embodiment of the present disclosure.

Referring to FIG. 3A, the electronic device 100 displays one or more objects including at least one of image information and shape information. The electronic device 100 detects a touch event for selecting one of such objects. When any object is selected through the detected object-selecting touch event, the electronic device 100 displays size-adjusting points to be used for adjusting the size of the selected object. For example, the size-adjusting points may be displayed at the corners and/or sides of the selected object.

Referring to FIG. 3B, the electronic device 100 detects a touch event from one of the size-adjusting points and displays a size-adjusted object in response to this touch event. At this time, the electronic device 100 may display both objects before and after the size adjustment in an overlay form, and/or may display a numerical value that indicates the quantity of the size adjustment. When the touch event is removed from the size-adjusting point, the electronic device 100 finishes the size adjustment of the selected object at a position from which the touch event is removed.

FIG. 4 is a flow diagram illustrating a method for editing a position of an object through a touch input according to an embodiment of the present disclosure.

Referring to FIG. 4, at operation 401, the electronic device 100 displays one or more objects. Each of the one or more objects may include at least one of image information and shape information.

At operation 403, the electronic device 100 detects a touch event for selecting one of such objects.

At operation 405, in response to the detected object-selecting touch event, the electronic device 100 not only displays size-adjusting points to be used for adjusting the size of the selected object, but also configures the selected object to enter a movable state (or otherwise sets the selected object to a movable state).

At operation 407, the electronic device 100 detects a touch event for moving the selected object and displays a moved object in response to the detected touch event. At this operation, the electronic device 100 may display a distance between the moved object and any adjacent object by means of a numerical value. According to various embodiments of the present disclosure, the object-selecting touch event and the object-moving touch event may a single sequent touch event (e.g., the object-selecting touch event and the object-moving touch event may not be separate individual touch events).

At operation 409, when the object-moving touch event is removed, the electronic device 100 finishes the movement of the selected object at a position from which the touch event is removed.

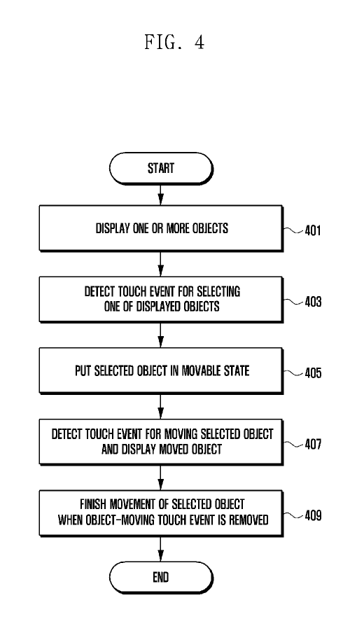

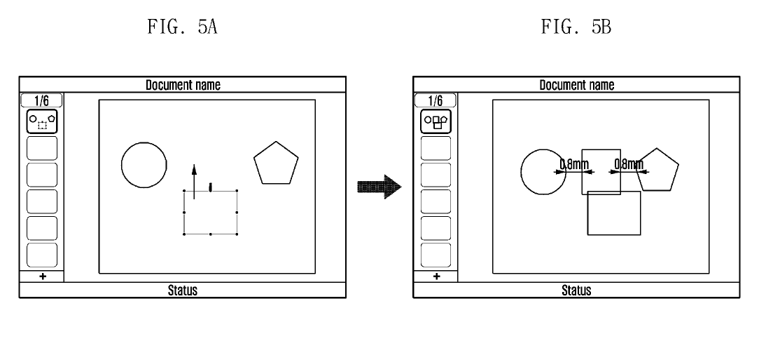

FIGS. 5A and 5B are screenshots illustrating a process of editing a position of an object through a touch input according to an embodiment of the present disclosure.

Referring to FIG. 5A, the electronic device 100 displays one or more objects including at least one of image information and shape information and detects a touch event for selecting one of such objects. If any object is selected through the object-selecting touch event, the electronic device 100 configures the selected object to enter a movable state (or otherwise sets the selected object to a movable state). For example, the electronic device 100 may configure the selected object to enter the movable state and concurrently display size-adjusting points of the selected object.

Referring to FIG. 5B, the electronic device 100 detects a touch event for moving the selected object and displays a moved object in response to the detected touch event. At this time, the electronic device 100 may display a numerical value that indicates a distance between the moved object and any adjacent object. When the object-moving touch event is removed from the selected object, the electronic device 100 finishes the movement of the selected object at a position from which the touch event is removed.

FIG. 6 is a flow diagram illustrating a method for arranging a position of an object through a touch input according to an embodiment of the present disclosure.

Referring to FIG. 6, at operation 601, the electronic device 100 displays one or more objects. Each of the one or more objects may include at least one of image information and shape information.

At operation 603, the electronic device 100 detects the first touch event for selecting a referential object among such objects.

At operation 605, the electronic device 100 detects the second touch event for arranging the other objects on the basis of the referential object. For example, the electronic device 100 detects a second touch event for arranging the other of the one or more objects relative to the referential object.

At operation 607, the electronic device 100 arranges the other objects to form a line with the referential object in response to the second touch event. For example, if the second touch event is a drag input in a horizontal direction, the electronic device 100 arranges the other objects to form a vertical line with the referential object. If the second touch event is a drag in a vertical direction, the electronic device 100 arranges the other objects to form a horizontal line with the referential object.

At operation 609, the electronic device 100 determines whether the arrangement of the one or more objects causes any overlay between adjacent objects.

If the electronic device 100 determines that the arrangement of the one or more objects causes an overlay between adjacent objects at operation 609, then the electronic device 100 may proceed to operation 611 at which the electronic device 100 detects the third touch event for changing the overlay order of objects. Thereafter, the electronic device 100 may proceed to operation 613.

At operation 613, the electronic device 100 changes the overlay order of objects in response to the third touch event.

In contrast, if the electronic device 100 determines that the arrangement of the one or more objects does not cause an overlay between adjacent objects at operation 609, then the electronic device 100 may end the method for arranging the position of the object.

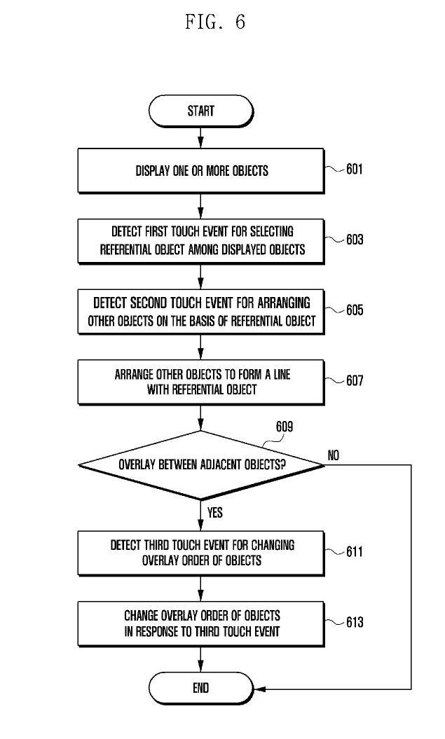

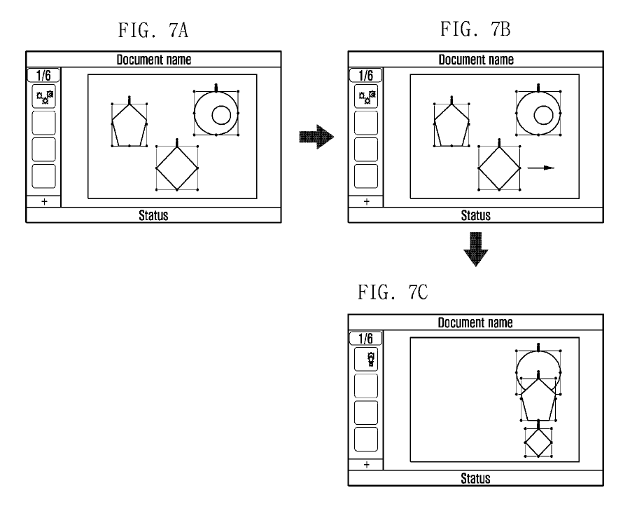

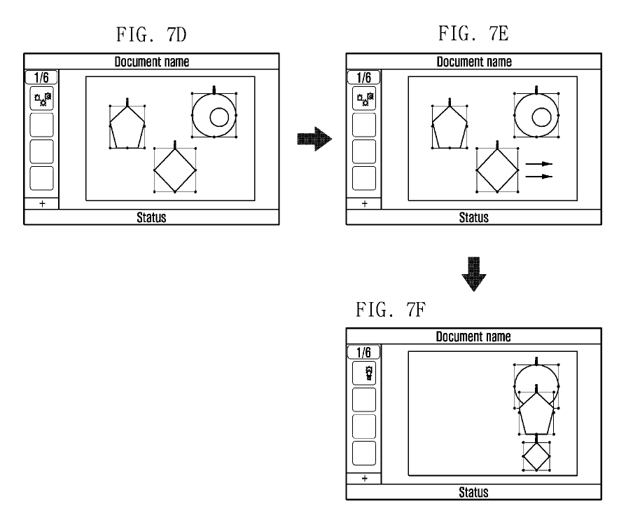

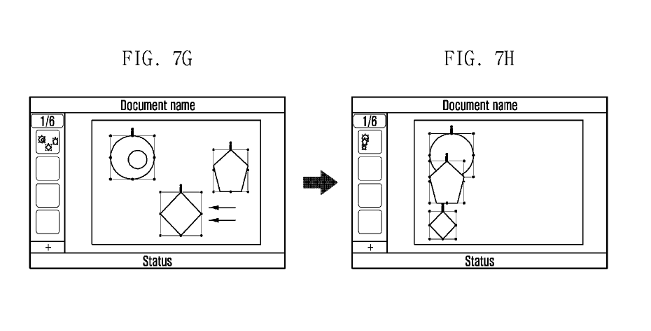

FIGS. 7A, 7B, 7C, 7D, 7E, 7F, 7G, and 7H are screenshots illustrating a process of arranging a position of an object through a touch input according to an embodiment of the present disclosure.

Referring to FIGS. 7A, 7B, and 7C, the electronic device 100 displays one or more objects. Each of the one or more objects may include at least one of image information and shape information. The electronic device 100 detects the first touch event for selecting a referential object among such objects. For example, as illustrated in FIG. 7A, the referential object is a circular object.

Thereafter, as illustrated in FIG, 7B the electronic device 100 detects the second touch event for arranging the other objects on the basis of the referential object. For example, the second touch event may be a drag action using a single finger.

Thereafter, as illustrated in FIG. 7C the electronic device 100 arranges the other objects to form a line with the referential object in response to the second touch event. For example, if the second touch event is a drag input in a horizontal direction, the electronic device 100 arranges a pentagonal object and a diamond-shaped object to form a vertical line with a circular object. The referential object and the other objects may be arranged such that the center points thereof are formed in a line.

Referring to FIGS. 7D, 7E, and 7F, the electronic device 100 displays one or more objects including at least one of image information and shape information and detects the first touch event for selecting a referential object among such objects. For example, as illustrated in FIG. 7D, the referential object is a circular object.

Thereafter, as illustrated in FIG. 7E, the electronic device 100 detects the second touch event for arranging the other objects on the basis of the referential object. For example, the second touch event may be a drag action using two fingers. For example, the electronic device 100 detects a second touch event for arranging the other of the one or more objects relative to the referential object.

Thereafter, as illustrated in FIG. 7F, the electronic device 100 arranges the other objects to form a line with the referential object in response to the second touch event. For example, if the second touch event is a drag input in a horizontal direction, the electronic device 100 arranges a pentagonal object and a diamond-shaped object to form a vertical line with a circular object. The referential object and the other objects may be arranged such that the right edges thereof are formed in a line.

Referring to FIGS. 7G and 7H, the electronic device 100 displays one or more objects. Each of the one or more objects may include at least one of image information and shape information. The electronic device 100 detects the first touch event for selecting a referential object among such objects. For example, as illustrated in FIG. 7G, the referential object is a circular object. Thereafter, the electronic device 100 detects the second touch event for arranging the other objects on the basis of the referential object. For example, the second touch event may be a leftward drag action using two fingers.

Thereafter, as illustrated in FIG. 7H, the electronic device 100 arranges the other objects to form a line with the referential object in response to the second touch event. For example, if the second touch event is a drag input in a horizontal direction, the electronic device 100 arranges a pentagonal object and a diamond-shaped object to form a vertical line with a circular object. The referential object and the other objects may be arranged such that the left edges thereof are formed in a line.

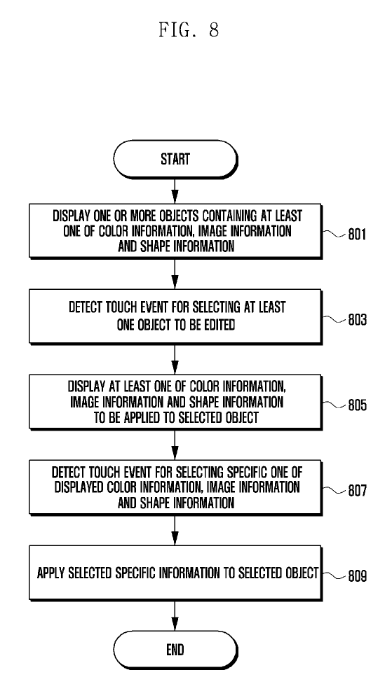

FIG. 8 is a flow diagram illustrating a method for editing an object through a touch input according to an embodiment of the present disclosure.

Referring to FIG. 8, at operation 801, the electronic device 100 displays one or more objects. Each of the one or more objects may include at least one of color information, image information, and shape information.

At operation 803, the electronic device 100 detects a touch event for selecting at least one of such objects to be edited.

At operation 805, in response to the detected touch event, the electronic device 100 displays at least one of color information, image information, and shape information to be applied to the selected object.

At operation 807, the electronic device 100 detects a touch event for selecting specific one of the displayed color information, image information, and shape information. According to various embodiments of the present disclosure, the touch event for selecting the displayed color information, the image information, and the shape information may correspond to a selection of one or more of the displayed color information, the image information, and the shape information.

At operation 809, the electronic device 100 applies the selected color information, image information, or shape information to the selected object. According to various embodiments of the present disclosure, the electronic device 100 may apply one or more of the selected displayed color information, the image information, and the shape information to the selected object.

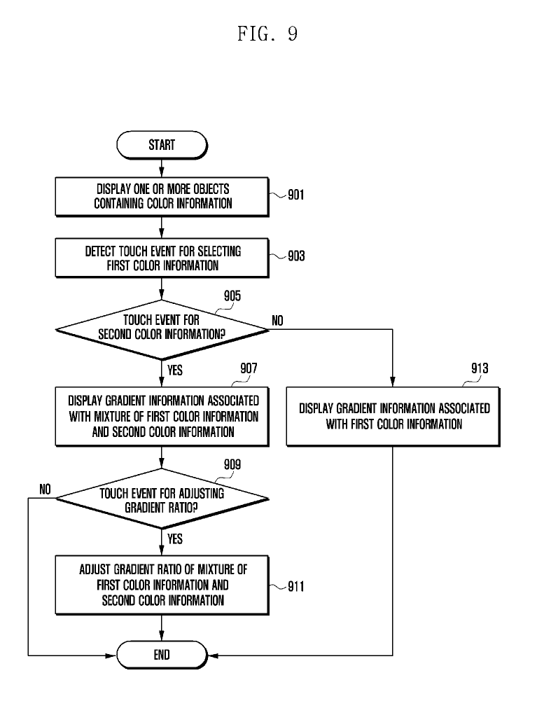

FIG. 9 is a flow diagram illustrating a method for editing color information of an object through a touch input according to an embodiment of the present disclosure.

At operation 901, the electronic device 100 displays one or more objects. Each of the one or more objects may include color information.

At operation 903, the electronic device 100 detects a touch event for selecting a specific object including the first color information among the displayed objects.

At operation 905, the electronic device 100 determines whether a touch event for selecting another object including the second color information among the displayed objects occurs. For example, the electronic device 100 determines whether a touch event for selecting another object including the second color information among the displayed objects is detected.

If the electronic device 100 determines that a touch event for selecting another object including the second color information among the displayed objects does not occur, then the electronic device 100 may proceed to operation 913 at which the electronic device 100 may display gradient information associated with the first color information.

In contrast, if the electronic device 100 determines that a touch event for selecting another object including the second color information among the displayed objects does occur, then the electronic device 100 may proceed to operation 907 at which the electronic device 100 may display gradient information associated with the mixture of the first color information and the second color information.

At operation 909, the electronic device 100 determines whether any touch event for adjusting a gradient ratio of the mixture of the first color information and the second color information occurs. For example, the electronic device 100 determines whether a touch event for adjusting a gradient ratio of the mixture of the first color information and the second color information is detected.

If the electronic device 100 determines that a touch event for adjusting a gradient ratio of the mixture of the first color information and the second color information does occur, then the electronic device 100 may proceed to operation 911 at which the electronic device 100 adjusts a gradient ratio.

In contrast, if the electronic device 100 determines that a touch event for adjusting a gradient ratio of the mixture of the first color information and the second color information does not occur, then the electronic device 100 may end the method for editing color information of an object.

FIG. 10 is a screenshot illustrating a process of editing color information of an object through a touch input according to an embodiment of the present disclosure.

Referring to FIG. 10, the electronic device 100 displays one or more objects. Each of the one or more objects may include color information. Thereafter, the electronic device 100 detects a touch event for selecting a specific object including the first color information among the displayed objects. In addition, the electronic device 100 determines whether a touch event for selecting another object including the second color information among the displayed objects occurs. If any touch event for selecting an object including the second color information occurs (e.g., if the electronic device 100 detects a touch event for selecting an object including the second color information), then the electronic device 100 may display gradient information associated with the mixture of the first color information and the second color information as shown in an image M1. Thereafter, the electronic device 100 determines whether any touch event for adjusting a gradient ratio of the mixture of the first color information and the second color information occurs. If such a touch event occurs (e.g., if the electronic device 100 detects a touch event for adjusting a gradient ratio of the mixture of the first color information and the second color information), then the electronic device 100 adjusts a gradient ratio as shown in an image M2. If no touch event occurs (e.g., if the electronic device 100 does not detect a touch event), then the electronic device 100 may display gradient information associated with the first color information as shown in an image M3.

FIG. 11 is a flow diagram illustrating a method for editing a color filter effect of an object through a touch input according to an embodiment of the present disclosure.

At operation 1101, the electronic device 100 displays one or more objects. Each of the one or more objects may include color information or image information. According to various embodiments of the present disclosure, each of the one or more objects may include one or more of the color information and the image information.

At operation 1103, the electronic device 100 detects a touch event for selecting at least one of such objects including color information.

At operation 1105, based on color information of the selected object, the electronic device 100 applies a color filter effect to a specific object including image information.

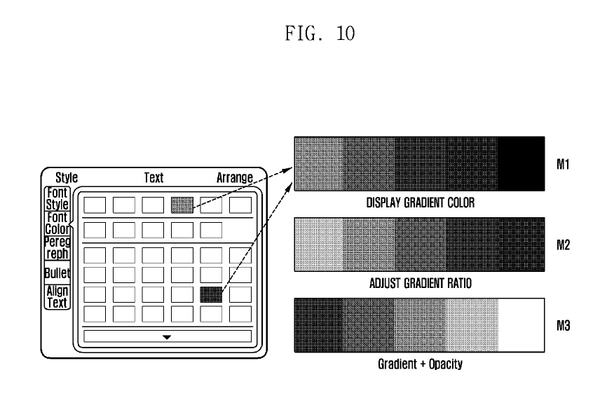

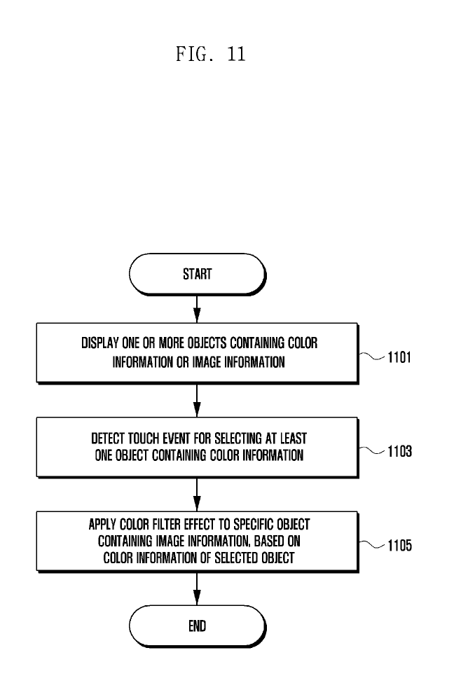

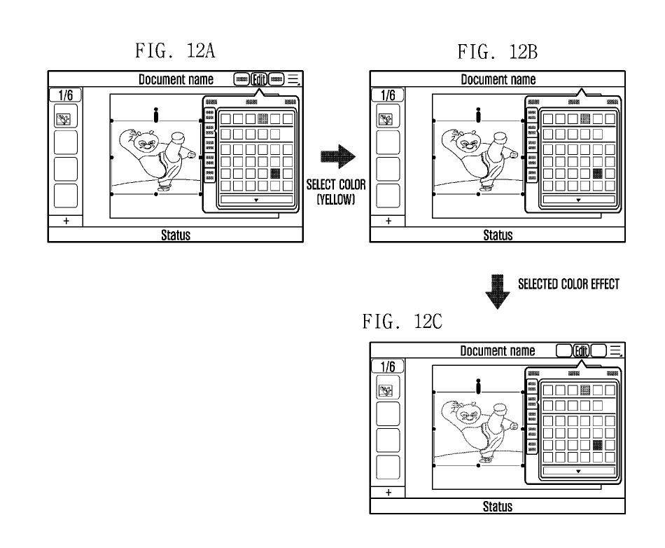

FIGS. 12A 12B, and 12C are screenshots illustrating a process of editing a color filter effect of an object through a touch input according to an embodiment of the present disclosure.

Referring to FIG. 12A, the electronic device 100 displays one or more objects. Each of the one or more objects may include color information or image information.

Referring to FIG. 12B, the electronic device 100 detects a touch event for selecting at least one of such objects including color information. For example, yellow information may be selected as shown.

Referring to FIG. 12C, the electronic device 100 then applies a color filter effect to a specific object including image information in accordance with color information of the selected object. For example, if a yellow filter effect is applied, image information of the specific object may be changed to a yellow tone.

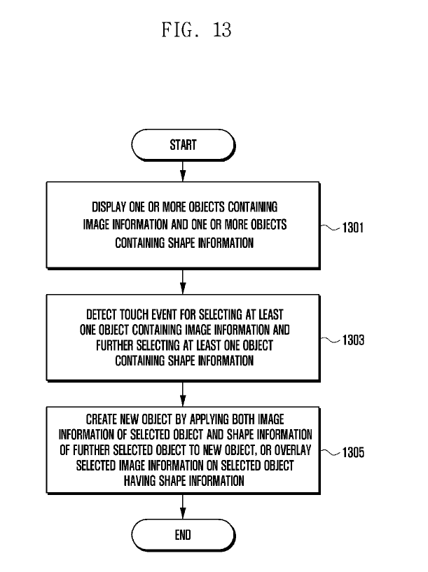

FIG. 13 is a flow diagram illustrating a method for editing a mask of an object through a touch input according to an embodiment of the present disclosure.

Referring to FIG. 13, at operation 1301, the electronic device 100 displays one or more objects each of which may include image information, and displays one or more objects each of which may include shape information.

At operation 1303, the electronic device 100 detects a touch event for selecting at least one of such objects including image information and further selecting at least one of such object including shape information.

At operation 1305, the electronic device 100 may create a new object by performing a masking process to simultaneously apply both image information of the selected object and shape information of the further selected object to the new object. A masking process may overlay a color or texture of the selected image information on a new object having a shape of the further selected object. Alternatively, a masking process may overlay a color or texture of the selected image information on the selected object having shape information.

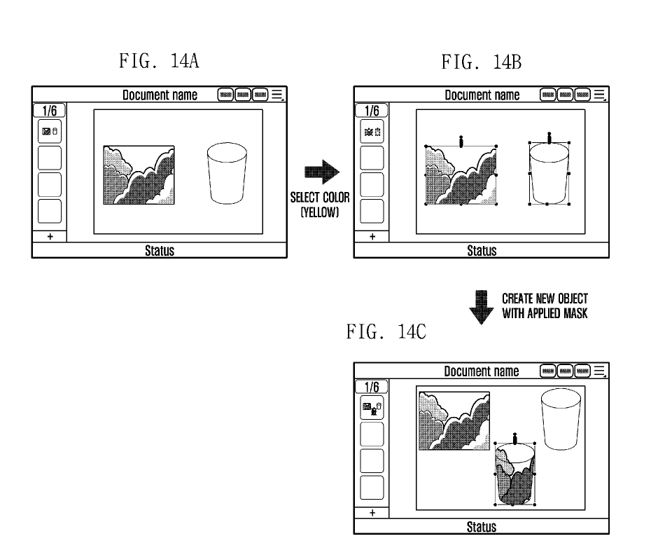

FIGS. 14A, 14B, and 14C are screenshots illustrating a process of editing a mask of an object through a touch input according to an embodiment of the present disclosure.

Referring to FIG. 14A, the electronic device 100 displays one or more objects including image information, and displays one or more objects including shape information.

Referring to FIG. 14B, the electronic device 100 detects a touch event for selecting at least one of such objects including image information, and further selecting at least one of such object including shape information.

Referring to FIG. 14C, the electronic device 100 may create a new object by masking both image information of the selected object and shape information of the further selected object to the new object. For example, both a sky image of the selected object and a cup shape of the further selected object may be simultaneously applied to a new object.

FIG. 15 is a flow diagram illustrating a method for editing shape information of an object through a touch input according to an embodiment of the present disclosure.

At operation 1501, the electronic device 100 displays one or more objects. Each of the one or more objects may include shape information.

At operation 1503, the electronic device 100 detects a touch event for selecting and moving at least one of such objects including shape information.

At operation 1505, if the selected and moved object is overlapped with any other object, the electronic device 100 may display various new shapes induced by such overlap.

At operation 1507, the electronic device 100 may detect a touch event for selecting one of the displayed new shapes.

At operation 1509, the electronic device 100 may create and display a new object having the selected new shape. Alternatively, the electronic device 100 may apply the selected new shape to the overlapped objects.

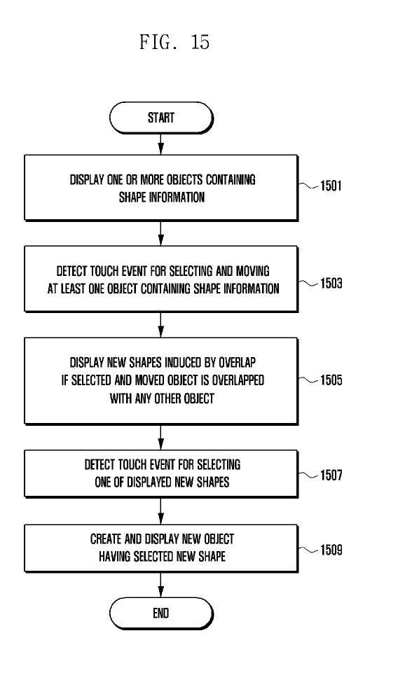

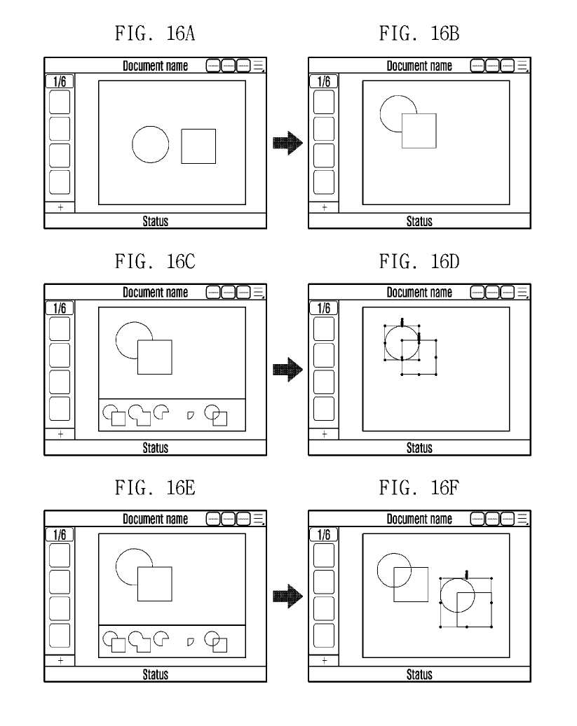

FIGS. 16A, 16B, 16C, 16D, 16E, and 16F are screenshots illustrating a process of editing shape information of an object through a touch input according to an embodiment of the present disclosure.

Referring to FIG. 16A, the electronic device 100 displays one or more objects including shape information.

Referring to FIG. 16B, the electronic device 100 detects a touch event for selecting and moving at least one of such objects including shape information.

Referring to FIGS. 16C and 16D, if the selected and moved object is overlapped with any other object, the electronic device 100 may display various new shapes induced by such overlap.

Referring to FIG. 16E, thereafter, the electronic device 100 may detect a touch event for selecting one of the displayed new shapes.

Referring to FIG. 16F, the electronic device 100 may create and display a new object having the selected new shape.

FIG. 17 is a flow diagram illustrating a method for editing image information of an object through a touch input according to an embodiment of the present disclosure.

Referring to FIG. 17, at operation 1701, the electronic device 100 displays one or more objects. Each of the one or more objects may include image information.

At operation 1703, the electronic device 100 detects a touch event for selecting at least one of such objects including image information.

At operation 1705, the electronic device 100 displays various combined images induced by combinations of the selected objects.

At operation 1707, the electronic device 100 detects a touch event for selecting one of the combined images.

At operation 1709, the electronic device 100 creates and displays a new object having the selected and combined image.

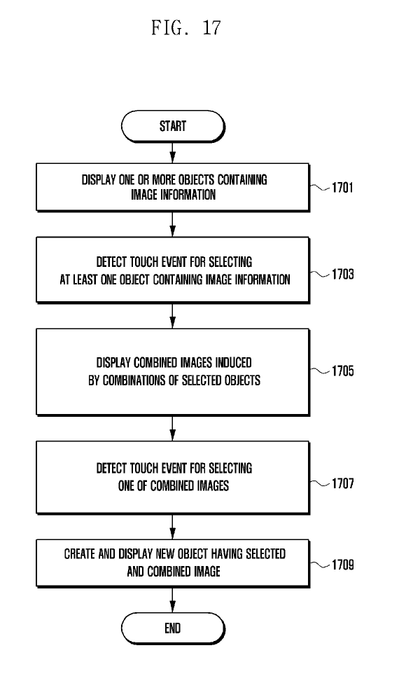

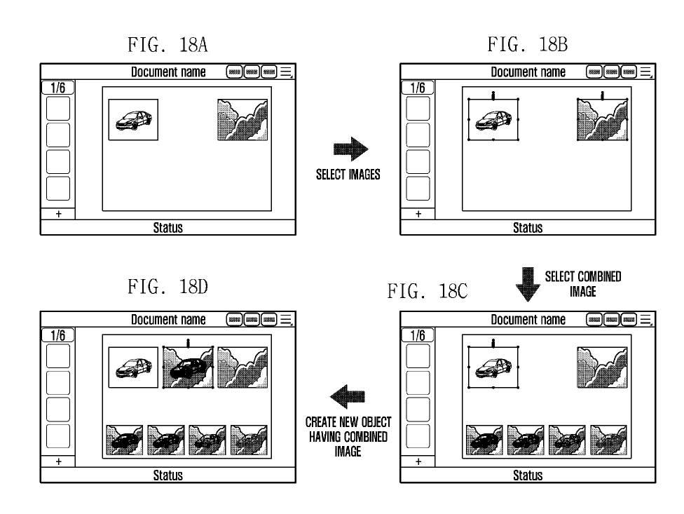

FIGS. 18A, 18B, 18C, and 18D are screenshots illustrating a process of editing image information of an object through a touch input according to an embodiment of the present disclosure.

Referring to FIG. 18A, the electronic device 100 displays one or more objects including image information.

Referring to FIG. 18B, the electronic device 100 detects a touch event for selecting at least one of such objects including image information.

Referring to FIG. 18C, the electronic device 100 then displays various combined images induced by combinations of the selected objects.

Referring to FIGS. 18C and 18D, if a touch event for selecting one of the combined images illustrated in FIG. 18C is detected, then the electronic device 100 creates and displays a new object having the selected and combined image as illustrated in FIG. 18D.

As fully discussed hereinbefore, the method for editing an object through a touch input in the electronic device may allow a user to edit the size, position, shape, color, image, arrangement, and/or the like of the object in various and intuitive manners.

It will be appreciated that various embodiments of the present disclosure according to the claims and description in the specification can be realized in the form of hardware, software or a combination of hardware and software.

Any such software may be stored in a non-transitory computer readable storage medium. The non-transitory computer readable storage medium stores one or more programs (software modules), the one or more programs comprising instructions, which when executed by one or more processors in an electronic device, cause the electronic device to perform a method of the present disclosure.

Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disk (CD), Digital Versatile Disc (DVD), magnetic disk or magnetic tape or the like. It will be appreciated that the storage devices and storage media are various embodiments of non-transitory machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a non-transitory machine-readable storage storing such a program.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for editing an object through a touch input in an electronic device, the method comprising:
displaying one or more objects each of which includes at least one of image information and shape information;
detecting a selecting touch event for selecting at least one of the one or more displayed objects;
detecting an editing touch event for editing at least one of a size, a position, and an arrangement of the at least one selected object; and
performing an edit process for at least one of the size, the position, and arrangement of the selected object in response to the editing touch event.

2. The method of claim 1, wherein the detecting of the editing touch event for editing the size of the at least one selected object comprises:
displaying size-adjusting points of the at least one selected object in response to the selecting touch event;
detecting the editing touch event on one of the size-adjusting points; and
displaying at least one size-adjusted object edited from the at least one selected object in response to the editing touch event.

3. The method of claim 2, wherein the performing of the edit process comprises:
finishing the edit process when the editing touch event is removed from the size-adjusting point.

4. The method of claim 3, wherein the displaying of the at least one size-adjusted object comprises at least one of:
displaying both the at least one selected object and the at least one size-adjusted object in an overlay form; and
displaying the quantity of size adjustment by means of a numerical value.

5. The method of claim 1, wherein the detecting of the editing touch event for editing the position of the at least one selected object comprises:
detecting the editing touch event for moving the at least one selected object; and
displaying a moved object edited from the at least one selected object in response to the editing touch event.

6. The method of claim 5, wherein the performing of the edit process comprises:
finishing the edit process when the editing touch event is removed from the moved object.

7. The method of claim 6, wherein the displaying of the moved object comprises:
displaying a distance between the moved object and an adjacent object by means of a numerical value.

8. The method of claim 1, wherein the detecting of the editing touch event for editing the arrangement of the at least one selected object comprises:
detecting a first touch event for selecting a referential object among the one or more displayed objects;
detecting a second touch event for arranging other objects on the basis of the reference object; and
arranging the other objects to form a line with the referential object in response to the second touch event.

9. The method of claim 8, wherein the detecting of the editing touch event for editing the arrangement of the at least one selected object further comprises:
determining whether an overlay between adjacent objects is caused by arrangement of the other objects;
if the overlay between adjacent objects occurs as a result of the arrangement of the other objects, detecting a third touch event for changing an overlay order of the objects; and
changing the overlay order of the objects in response to the third touch event.

10. A non-transitory computer-readable storage medium storing instructions that, when executed, cause at least one processor to perform the method of claim 1.

11. A method for editing an object through a touch input in an electronic device, the method comprising:
displaying one or more objects each of which includes at least one of color information, image information, and shape information;
detecting a touch event for selecting at least one of the one or more displayed objects;
displaying at least one of the color information, the image information, and the shape information to be applied to the at least one selected object;
detecting a touch event for selecting one of the color information, the image information, and the shape information; and
applying the selected one of the color information, the image information, and the shape information to the at least one selected object.

12. The method of claim 11, wherein the displaying of the at least one of the color information, the image information and the shape information comprises:
displaying one or more objects including color information;
detecting a touch event for selecting a specific object including first color information among the one or more displayed objects;
determining whether a touch event for selecting another object including second color information among the displayed objects occurs; and
displaying gradient information associated with the mixture of the first color information and the second color information when the touch event for selecting another object including the second color information occurs.

13. The method of claim 12, wherein the displaying of the at least one of the color information, the image information, and the shape information further comprises:
detecting a touch event for adjusting a gradient ratio of a mixture of the first color information and the second color information; and
adjusting the gradient ratio in response to the touch event for adjusting the gradient ratio.

14. The method of claim 12, wherein the displaying of the at least one of the color information, the image information, and the shape information further comprises:
displaying gradient information associated with the first color information when the touch event for selecting another object including the second color information does not occur.

15. The method of claim 14, wherein displaying gradient information associated with the first color information when the touch event for selecting another object including the second color information does not occur comprises:
determining whether the touch event for selecting another object including the second color information is detected within a preset threshold amount of time; and
displaying the gradient information associated with the first color information if the touch event for selecting another object including the second color information is not detected within the preset threshold amount of time.

16. The method of claim 11, wherein the displaying of the at least one of the color information, the image information, and the shape information comprises:
displaying one or more objects including at least one of color information and image information;
detecting a touch event for selecting a specific object including the color information among the displayed objects; and
applying a color filter effect to a specific object including the image information, based on the color information of the at least one selected object.

17. The method of claim 11, wherein the displaying of the at least one of the color information, the image information, and the shape information comprises:
displaying one or more objects each of which includes image information and displaying one or more objects each of which includes shape information;
detecting a touch event for selecting at least one object including the image information and at least one object including the shape information; and
creating a new object by performing a masking process to simultaneously apply both the image information of the at least one selected object and the shape information of the at least one selected object to the new object, or overlaying the image information of the at least one selected object on the at least one selected object having the shape information.

18. The method of claim 11, wherein the displaying of the at least one of the color information, the image information, and the shape information comprises:
displaying one or more objects each of which includes shape information;
detecting a touch event for selecting and moving at least one of the objects including the shape information;
if the at least one selected and moved object is overlapped with other object, displaying new shapes induced by the overlap; and
detecting a touch event for selecting one of the displayed new shapes.

19. The method of claim 11, wherein the displaying of the at least one of the color information, the image information, and the shape information comprises:
displaying one or more objects each of which includes image information;
detecting a touch event for selecting at least one object including the image information;
displaying combined images induced by combinations of the at least one selected object; and
detecting a touch event for selecting one of the combined images.

20. A non-transitory computer-readable storage medium storing instructions that, when executed, cause at least one processor to perform the method of claim 11.

21. An electronic device comprising:
a touch screen configured to display one or more objects each of which includes at least one of image information and shape information, in response to a touch input; and
a control unit configured to detect a selecting touch event for selecting at least one of the displayed objects through the touch screen, to detect an editing touch event for editing at least one of a size, a position, and an arrangement of the at least one selected object through the touch screen, and to perform an edit process for the at least one of the size, the position, and the arrangement of the at least one selected object in response to the editing touch event.

22. The electronic device of claim 21, wherein the control unit is further configured to control the touch screen to display size-adjusting points of the at least one selected object in response to the selecting touch event, to detect the editing touch event on one of the size-adjusting points, to control the touch screen to display at least one size-adjusted object edited from the at least one selected object in response to the editing touch event, and to finish the edit process when the editing touch event is removed from the size-adjusting point.

23. The electronic device of claim 21, wherein the control unit is further configured to detect the editing touch event for moving the at least one selected object, to control the touch screen to display a moved object edited from the at least one selected object in response to the editing touch event, and to finish the edit process when the editing touch event is removed from the moved object.

24. The electronic device of claim 21, wherein the control unit is further configured to detect a first touch event for selecting a referential object among the one or more displayed objects, to detect a second touch event for arranging other objects on the basis of the reference object, to arrange the other objects to form a line with the referential object in response to the second touch event, to determine whether an overlay between adjacent objects is caused by arrangement of the other objects, to detect a third touch event for changing an overlay order of the objects if the overlay between adjacent objects occurs as a result of the arrangement of the other objects, and to change the overlay order of the objects in response to the third touch event.

25. An electronic device comprising:
a touch screen configured to display one or more objects each of which includes at least one of color information, image information, and shape information, in response to a touch input; and
a control unit configured to detect a touch event for selecting at least one of the one or more displayed objects through the touch screen, to control the touch screen to display at least one of the color information, the image information and the shape information to be applied to the at least one selected object, to detect a touch event for selecting one of the color information, the image information and the shape information through the touch screen, and to apply the selected one of the color information, the image information and the shape information to the at least one selected object.

26. The electronic device of claim 25, wherein the control unit is further configured to control the touch screen to display one or more objects including color information, to detect a touch event for selecting a specific object including first color information among the one or more displayed objects, to determine whether a touch event for selecting another object including second color information among the displayed objects occurs, and to control the touch screen to display gradient information associated with the mixture of the first color information and the second color information when the touch event for selecting another object including the second color information occurs.

27. The electronic device of claim 26, wherein the control unit is further configured to detect a touch event for adjusting a gradient ratio of a mixture of the first color information and the second color information, and to adjust the gradient ratio in response to the touch event for adjusting the gradient ratio.

28. The electronic device of claim 26, wherein the control unit is further configured to control the touch screen to display gradient information associated with the first color information when the touch event for selecting another object including the second color information does not occur.

29. The electronic device of claim 28, wherein the control unit is further configured to determine whether the touch event for selecting another object including the second color information is detected within a preset threshold amount of time, and to display the gradient information associated with the first color information if the touch event for selecting another object including the second color information is not detected within the preset threshold amount of time.

30. The electronic device of claim 25, wherein the control unit is further configured to control the touch screen to display one or more objects including at least one of color information and image information, to detect a touch event for selecting a specific object including the color information among the displayed objects, and to apply a color filter effect to a specific object including the image information, based on the color information of the at least one selected object.

31. The electronic device of claim 25, wherein the control unit is further configured to control the touch screen to display one or more objects each of which includes image information and display one or more objects each of which includes shape information, to detect a touch event for selecting at least one object including the image information and at least one object including the shape information, and to create a new object by performing a masking process to simultaneously apply both the image information of the at least one selected object and the shape information of the at least one selected object to the new object, or to overlay the image information of the at least one selected object on the at least one selected object having the shape information.

32. The electronic device of claim 25, wherein the control unit is further configured to control the touch screen to display one or more objects each of which includes shape information, to detect a touch event for selecting and moving at least one of the objects including the shape information, to control the touch screen to displaying new shapes induced by overlap if the at least one selected and moved object is overlapped with other object, and to detect a touch event for selecting one of the displayed new shapes.

33. The electronic device of claim 25, wherein the control unit is further configured to control the touch screen to display one or more objects each of which includes image information, to detect a touch event for selecting at least one object including the image information, to control the touch screen to display combined images induced by combinations of the at least one selected object, and to detect a touch event for selecting one of the combined images.
